(19) United States
(12) Patent Application Publication
(10) Pub. No.: US 2026/0043963 A1
(43) Pub. Date: Feb. 12, 2026

(54) OPTICAL WAVEGUIDES AND METHODS OF MAKING SAME

(71) Applicant: 3M INNOVATIVE PROPERTIES COMPANY, St. Paul, MN (US)

(72) Inventors: Craig R. Schardt, Woodbury, MN (US); Henrik B. van Lengerich, Woodbury, MN (US); Kevin W. Gotrik, Hudson, WI (US); Steven D. Theiss, Woodbury, MN (US); Martin B. Wolk, Woodbury, MN (US); Cedric Bedoya, Woodbury, MN (US); Daniel J. Schmidt, Woodbury, MN (US)

(21) Appl. No.: 19/104,275

(22) PCT Filed: Aug. 9, 2023
(86) PCT No.: PCT/IB2023/058061

§ 371 Date: Feb. 17, 2025

Related U.S. Application Data
(60) Provisional application No. 63/373,583, filed on Aug. 26, 2022.

(51) Int. Cl. G02B 6/12; G02B 6/122; G02B 6/13

(52) U.S. Cl. CPC G02B 6/12004; G02B 6/1223; G02B 6/13; G02B 2006/12038; G02B 2006/12107

(57) ABSTRACT

An optical waveguide (200) includes an optical core (30) configured to propagate an image light therealong, and first and second multilayer gratings (40) disposed on the optical core (30). The first multilayer grating (40a) is configured to receive an image light from an image projector (70a) and inject at least a portion of the received image light into the optical core (30). The injected image light propagates along the optical core (30) by total internal reflection. The second multilayer grating (40b) is configured to receive a portion of the injected image light and extract a portion of the received injected image light from the optical core (30) for viewing. Each of the first and second multilayer gratings (40) include an inorganic undulating layer (60) having a wave-like shape along a width direction and a planarizing adhesive layer (50) disposed between the undulating layer (60) and the optical core (30) and planarizing one of the undulating major surfaces of the inorganic undulating layer (60).

### SUMMARY

In some aspects of the present description, an optical waveguide is provided, the optical waveguide including an optical core configured to propagate an image light therealong, and first and second multilayer gratings disposed on the optical core. The first multilayer grating is configured to receive an image light from an image projector and inject at least a portion of the received image light into the optical core. The injected image light propagates along the optical core primarily by total internal reflection. The second multilayer grating is configured to receive at least a portion of the injected image light and extract at least a portion of the received injected image light from the optical core for viewing by a viewer. Each of the first and second multilayer gratings include an inorganic undulating layer and a planarizing adhesive layer. The inorganic undulating layer includes opposing outermost undulating major surfaces nestingly aligned with each other to create a wave-like shape along a width direction of the inorganic undulating layer and to form a plurality of substantially parallel ridges and grooves. The ridges and the grooves extend along an orthogonal length direction of the inorganic undulating layer. The planarizing adhesive layer is disposed between the inorganic undulating layer and the optical core and substantially planarizes one of the undulating major surfaces of the inorganic undulating layer and bonds the inorganic undulating layer to the optical core.

In some aspects of the present description, an optical waveguide is provided, the optical waveguide including an optical core configured to propagate an image light therealong, and a continuous seamless multilayer disposed on a major side of the optical core. The continuous seamless multilayer includes a continuous seamless inorganic layer and a continuous seamless adhesive layer. The continuous seamless inorganic layer undulates in a plurality of discrete spaced apart regions of the inorganic layer to form a plurality of spaced apart undulated inorganic layer portions of an otherwise non-undulated inorganic layer. Each of the undulated inorganic layer portions includes opposing outermost undulating major surfaces nestingly aligned with each other and forming a plurality of substantially parallel ridges and grooves of the undulated inorganic layer portion extending along a length-direction of the undulated inorganic layer portion and arranged along an orthogonal width-direction of the undulated inorganic layer portion. The continuous seamless adhesive layer is disposed between the inorganic layer and the optical core and substantially conforms to the ridges and grooves of each of the undulated inorganic layer portion and bonds the inorganic layer to the optical core. A first undulated inorganic layer of the undulated inorganic layer portions is configured to receive an image light from an image projector and inject at least a portion of the received image light into the optical core. The injected image light propagates along the optical core primarily by total internal reflection. A second undulated inorganic layer portion of the undulated inorganic layer portions is configured to receive at least a portion of the injected image light along a first direction and redirect the injected image light as a redirected image light propagating along a different second direction along the optical core primarily by total internal reflection. A third undulated inorganic layer portion of the undulated inorganic layer portions is configured to receive at least a portion of the redirected image light and extract at least a portion of the received redirected image light from the optical core for viewing by a viewer.

In some aspects of the present description, a method of making an optical waveguide is provided, the method including providing a temporary carrier including a major structured surface having, in a plurality of discrete spaced apart regions, a plurality of alternating first ridges and first grooves: conformally disposing an inorganic layer on the major structured surface of the temporary carrier so that both a first major surface thereof facing the temporary carrier and a second major surface thereof facing away from the carrier substantially conform to the major structured top surface of the temporary carrier to form a continuous seamless inorganic layer having a plurality of undulated inorganic layer portions in an otherwise non-undulated inorganic layer. In each of the undulated inorganic layer portions, the first and second major surfaces of the layer portion define a spacing average S_{avg} and a spacing standard of deviation S_{sd} therebetween, such that S_{sd}/S_{avg} is less than about 0.5 substantially conformally coating the second major surface of the inorganic with an adhesive layer and substantially planarizing the inorganic layer to form a structured adhesive layer having a major structured top surface facing and substantially conforming to the second major surface of the inorganic layer and an opposing substantially planar major surface: adhering the substantially planar major surface of the structured adhesive layer to a major surface of an optical core configured to propagate an image light therealong primarily by total internal reflection; and removing the temporary carrier from the first major surface of the inorganic layer.

### BRIEF DESCRIPTION OF THE DRAWINGS

FIGS. 1A and 1B include side views of a portion of an optical waveguide including a multilayer grating, in accordance with an embodiment of the present description;

FIG. 2 is a scanning electron microscope image of a multilayer grating, in accordance with an embodiment of the present description:

FIG. 3 is a process flow illustrating a method of making an optical waveguide with a multilayer grating, in accordance with an embodiment of the present description:

FIG. 4 is a side view of an optical waveguide including two multilayer grating sections, in accordance with an embodiment of the present description:

FIG. 5 provides an alternate view of the optical waveguide of FIG. 4, in accordance with an embodiment of the present description:

FIGS. 6A and 6B include side views of the architecture of a multilayer grating, in accordance with an embodiment of the present description:

FIG. 7 is a side view of an optical waveguide including multilayer grating sections on opposing sides of an optical core, in accordance with an alternate embodiment of the present description:

FIG. 8 is a side view of an optical waveguide, in accordance with another alternate embodiment of the present description:

FIGS. 9A and 9B provide top and side views, respectively, of an optical waveguide including three multilayer grating sections, in accordance with an alternate embodiment of the present description:

FIGS. 10A and 10B provide illustrative examples of alternative shapes for the features on a multilayer grating, in accordance with an embodiment of the present description:

FIGS. 11A and 11B provide additional illustrative examples of alternative shapes for the features on a multilayer grating, in accordance with an embodiment of the present description; and

FIG. 12 is an illustrative example of methods for measuring dimensions on an undulating layer of a multilayer grating, in accordance with an embodiment of the present description

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Nano-structured films may be useful in optical laminates or as transfer films based on subwavelength optics such as diffractive optical elements and optical meta-surfaces. Transfer films may be used to fabricate image-preserving waveguides for augmented reality devices. The optical performance of these waveguides is dependent upon the index contrast (i.e., difference in refractive index) between the grating structure and the surrounding medium, which could be the template film (e.g., polymer, with a refractive index around 1.5) or air (if the template is removed in a subsequent process step). Therefore, there is a need for methods to maximize the refractive index of a templated nanostructure for use in its final article.

Fabrication of high-index, sub-wavelength gratings and nanostructures is typically done using “batch processing” with methods developed for the semiconductor industry. The process starts by depositing a dense layer of TiO₂ on a substrate (e.g., high index glass wafer). The TiO₂ layer is coated with a polymeric resist, which is then patterned via a lithographic technique such as photolithography, nano-imprint lithography, or e-beam lithography to define the desired pattern in the resist. The pattern in the resist is then transferred into the TiO₂ layer by etching and finally the resist is removed, leaving behind the patterned TiO₂.

The transfer film approach described herein is fundamentally different from the batch processing approach typically used and may be far more suitable to high-volume and lower cost production of sub-wavelength optical structures. The transfer film approach achieves this by fabricating the high-index TiO₂ sub-wavelength structure on a polymeric template structure on a carrier film. Once the structure is made, it is transferred to a final substrate (e.g., a high-index glass wafer) with an ultra-thin adhesive (less than 500 nm and preferably less than 100 nm thick to maintain good optical coupling), and the carrier substrate and optionally the template layer is removed. This enables use of high-capacity roll-to-roll processing to create the high index structures on the final substrate.

According to some aspects of the present description, an optical waveguide includes an optical core configured to propagate an optical mode at a first wavelength therealong, and a multilayer grating disposed on the optical core and configured to extract the optical mode that would otherwise propagate along the optical core along a first direction (e.g., in an x-axis relative to the waveguide).

In some embodiments, the multilayer grating may include an adhesive layer and an inorganic layer. In some embodiments, the adhesive layer may include a major bottom surface facing the optical core and an opposing structured major top surface facing away and spaced apart from the optical core. In some embodiments, the structured major top surface may include a plurality of substantially parallel linear grating elements extending along a same length direction (e.g., a y-axis) of the grating elements and arranged along an orthogonal width direction (e.g., an x-axis) of the grating elements. In some embodiments, the plurality of substantially parallel linear grating elements may form a periodic pattern along the width direction of the grating elements. In some such embodiments, the periodic pattern may have a period in a range from about 100 nm to about 1000 nm, or from about 150 nm to about 750 nm, or from about 200 nm to about 700 nm, or from about 250 nm to about 600 nm, or from about 300 nm to about 550 nm, or from about 300 nm to about 500 nm, or from about 300 nm to about 450 nm. In some embodiments, the width direction of the grating elements may be substantially parallel to the first direction.

In some embodiments, the inorganic layer may be disposed on and may conform to the structured major top surface of the adhesive layer so that the inorganic layer has a thickness standard deviation that is less than about 50%, or less than about 45%, or less than about 40%, or less than about 35%, or less than about 30%, or less than about 25%, or less than about 20% of an average thickness of the inorganic layer.

In some embodiments, the optical core may have an average thickness of between about 100 microns and about 2000 microns, or between about 150 microns and about 1500 microns, or between about 200 microns and about 1250 microns, or between about 250 microns and about 1250 microns, or between about 300 microns and about 1000 microns. In some embodiments the optical core may have a thickness of up to 5000 microns, or up to 7500 microns, or up to 10,000 microns.

In some embodiments, a minimum spacing between the optical core and the major top surface of the adhesive layer may be greater than about 5 nm, or greater than about 10 nm, or greater than about 15 nm, or greater than about 20 nm, or greater than about 25 nm, or greater than about 30 nm, or greater than about 35 nm, or greater than about 40 nm, or greater than about 45 nm, or greater than about 50 nm.

In some embodiments, the optical waveguide may further include a cover layer disposed on and substantially planarizing the inorganic layer. In some embodiments, the inorganic layer may include one or more of titanium dioxide (TiO₂), zirconium oxide (ZrOₓ), titanium oxide (TiOₓ), SiO₂, Al₂O₃, CeO₂, ZnO, Nb₂O₅, Ta₂O₅, HfO₂, SiAlOₓN_{y}, Si₃N₄, Nb-doped TiO₂, and ZrO₂. In some embodiments, at the first wavelength, an index of refraction of the cover layer may be less than an index of refraction of the inorganic layer by at least 0.5, or at least 0.6, or at least 0.7, or at least 0.8, or at least 0.9, or at least 1.0, or at least 1.2.

In some embodiments, an optical system may include any of the optical waveguides described herein, at least one light source disposed so as to inject light at the first wavelength into the optical core of the optical waveguide, such that the injected light propagates along the optical core along the first direction as the optical mode.

According to some aspects of the present description, an optical waveguide includes an optical core configured to propagate an image light therealong primarily by total internal reflection, a structured adhesive layer, and an inorganic layer. In some embodiments, the structured adhesive layer may include a major bottom surface facing, and bonded to, the optical core and an opposing major structured top surface including a plurality of alternating ridges and grooves. In some embodiments, an average spacing between the grooves and the optical core may be greater than about 5 nm, or about 10 nm, or about 15 nm, or about 20 nm, or about 25 nm, or about 30 nm, or about 35 nm, or about 40 nm, or about 45 nm, or about 50 nm. In some embodiments, the average spacing between the grooves and the optical core may be less than about 500 nm, or about 450 nm, or about 400 nm, or about 350 nm, or about 300 nm, or about 250 nm, or about 200 nm, or about 150 nm, or about 100 nm. In some embodiments, a minimum spacing between the grooves and the optical core may be greater than about 5 nm, or about 10 nm, or about 15 nm, or about 20 nm, or about 25 nm, or about 30 nm, or about 35 nm, or about 40 nm, or about 45 nm, or about 50 nm.

As used herein, the terms “ridge” and “groove” shall be defined as follows. A ridge is any undulation in a layer for which the material of the layer is pushed “up” away from the optical core, forming a projection extending in a direction that is away from the optical core. Conversely, a groove is any undulation in a layer for which the material of the layer is pushed “down” toward the optical core, forming a depression extending in a direction toward the optical core.

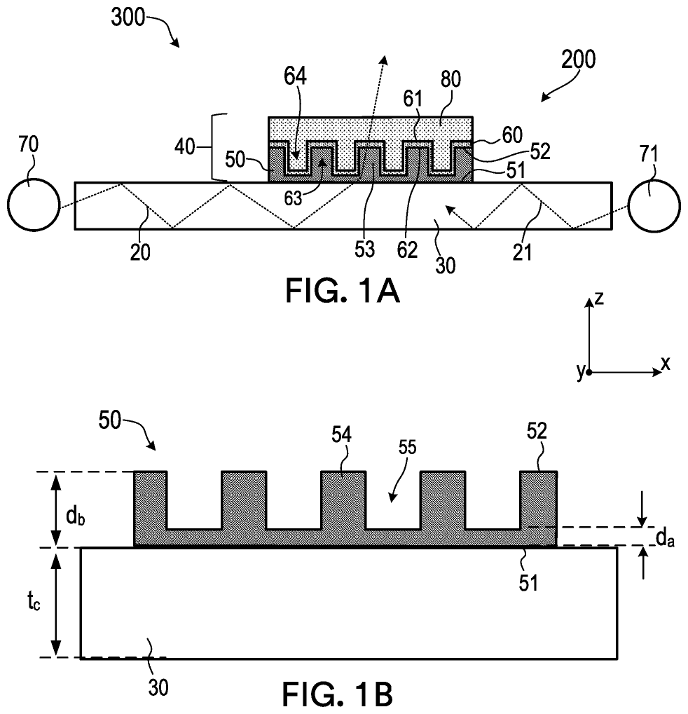

Both ridges and grooves may be considered “concavities” in a layer, but concavities facing in different directions. For example, each concavity has an open end and a closed end (e.g., a “cup-like” shape). In a “ridge” concavity, the open end of the concavity faces “down” toward the optical core (the negative z-direction of FIG. 1) and the closed end is projected “up” away from the optical core (the positive z-direction of FIG. 1, shown by the arrow on the coordinate system graphic). A “groove” concavity, conversely, has an open end that faces “up” away from the optical core, and a closed end that faces “down” toward the optical core. These definitions are provided for clarity in understanding the figures and language of this specification.

In some embodiments, for at least one visible wavelength in a visible (human-visible) wavelength range extending from about 420 nm to about 680 nm, the structured adhesive has an index of refraction of between about 1.35 to about 2.5. In some embodiments, for at least one visible wavelength in a visible wavelength range extending from about 420 nm to about 680 nm, the structured adhesive has an index of refraction of about 1.5.

In some embodiments, the inorganic layer may be conformally disposed on the major structured top surface of the structured adhesive layer so that opposing first and second major surfaces of the inorganic layer substantially conform to the major structured top surface of the structured adhesive layer, and the first and second major surfaces of the inorganic layer define an average spacing of between about 10 nm to about 100 nm, or about 20 nm to about 90 nm, or about 30 nm to about 80 nm, or about 40 nm to about 70 nm, or about 40 nm to about 60 nm, therebetween. In some embodiments, the inorganic layer may have an index of refraction of greater than about 1.5, or about 1.6, or about 1.7, or about 1.8, or about 1.9, or about 2.0, or about 2.1, or about 2.2, or about 2.3, or about 2.4 at a wavelength of about 580 nm.

In some embodiments, the optical core may have an index of refraction of greater than about 1.5, or greater than about 1.6, or greater than about 1.7, or greater than about 1.8, or greater than about 1.9, or greater than about 2.0 at a wavelength of about 580 nm. In some embodiments, the optical core may include one or more of tantalum, niobium, lanthanum, lead, barium, titanium, zirconium, and bismuth. In some embodiments, the optical core may be a polymer. In some embodiments the optical core may include one or more of, but not limited to, polymethacrylate, polycarbonate, polyester, polyphosphonate, polysulfone, silicone, epoxy, or polyimide constituents. In some embodiments, the optical core may include nanoparticles. In some embodiments, the optical core may include nanoparticles of titania, or zirconia.

According to some aspects of the present description, an optical waveguide includes an optical core configured to propagate an image light therealong primarily by total internal reflection, an inorganic layer, and a structured adhesive layer. In some embodiments, the inorganic layer may be disposed on the optical core and may define a plurality of alternating first and second concavities, wherein the first concavities are concave toward the optical core, and the second concavities are convex toward the optical core. In some embodiments, the structured adhesive layer may be disposed between the optical core and the inorganic layer and bonding them to each other. In some embodiments, the structured adhesive layer may substantially fill the first concavities.

For each pair of adjacent first and second concavities, the first and second concavities may be separated by a common side wall extending from a first rounded side wall corner joining the common side wall to a bottom of the second concavity to an opposite second rounded side wall corner joining the common side wall to a bottom of the first concavity. In a first planar cross-section (e.g., in an xz-plane of the optical waveguide) substantially orthogonal to the common side wall, the first rounded side wall corner may include an outer first circumferential surface facing the optical core and having a first radius of curvature R1. In some embodiments, the second rounded side wall corner may include an outer second circumferential surface facing away from the optical core and having a second radius of curvature R2. In some embodiments, R1 may be greater than R2 for at least a plurality of pairs of adjacent first and second concavities.

According to some aspects of the present description, an optical waveguide may include an optical core configured to propagate an image light therealong primarily by total internal reflection, an inorganic layer, and a structured adhesive layer. In some embodiments, the inorganic layer may be disposed on the optical core and may define a plurality of alternating first and second concavities. In some embodiments, the first concavities may be concave toward the optical core, and the second concavities may be convex toward the optical core.

In some embodiments, the structured adhesive layer may be disposed between the optical core and the inorganic layer and may bond the optical core to the inorganic layer. In some embodiments, the structured adhesive layer may substantially fill the first concavities. In some embodiments, for each pair of adjacent first and second concavities, the first and second concavities may be separated by a common side wall extending from a first rounded side wall corner joining the common side wall to a bottom of the second concavity to an opposite second rounded side wall corner joining the common side wall to a bottom of the first concavity. In some embodiments, the first rounded side wall corner may be closer to the optical core and the second rounded side wall corner may be farther from the optical core.

In some embodiments, in a first planar cross-section (e.g., an xz-plane of the optical waveguide) substantially orthogonal to the common side wall, the first rounded side wall corner may include an outer first circumferential surface facing the optical core and having a first outer radius of curvature R1, and an inner first circumferential surface facing away from the optical core and having a first inner radius of curvature R1. In some embodiments, R1 may be greater than R1′ for at least a plurality of pairs of adjacent first and second concavities. In some embodiments, the value of R1−R1′ may be at least 10 nm, or at least 20 nm, or at least 30 nm, or at least 40 nm, or at least 50 nm.

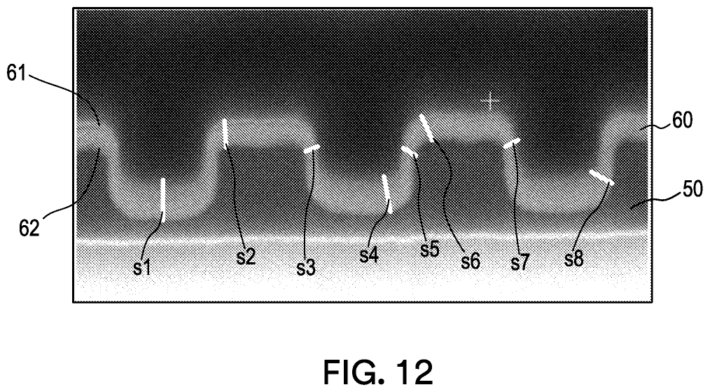

According to some aspects of the present description, a method of making an optical waveguide may include providing a temporary carrier including a major structured surface having a plurality of alternating first ridges and first grooves: conformally disposing an inorganic layer on the major structured surface of the temporary carrier so that both a first major surface thereof facing the temporary carrier and a second major surface thereof facing away from the carrier substantially conform to the major structured top surface of the temporary carrier such that the first and second major surfaces of the inorganic layer define a spacing average S_{avg} and a spacing standard of deviation S_{sd} therebetween, S_{sd}/S_{avg} less than about 0.5, or about 0.4, or about 0.3, or about 0.2, or about 0.17, or about 0.15, or about 0.12, or about 0.1; disposing an adhesive layer on the second major surface of the inorganic layer and substantially planarizing the inorganic layer to form a structured adhesive layer having a major structured top surface facing and substantially conforming to the second major surface of the inorganic layer and an opposing substantially planar major surface; and adhering the substantially planar major surface of the structured adhesive layer to a major surface of an optical core configured to propagate an image light therealong primarily by total internal reflection; and removing the temporary carrier from the first major surface of the inorganic layer. Refer to the discussion of FIG. 12 herein for additional detail on the values of S_{avg} and S_{sd} and how the measurements may be determined.

In some embodiments, the method of making an optical waveguide may further include disposing a cover material on the first major surface of the inorganic layer and substantially planarizing the inorganic layer to form a structured cover layer having a major structured surface facing and substantially conforming to the first major surface of the inorganic layer and an opposing substantially planar major surface. In some embodiments, the step of providing the temporary carrier includes providing a tool having a major structured surface comprising a plurality of alternating ridges and grooves; and disposing a temporary carrier material on the major structured surface of the tool to form a temporary carrier having a major structured surface facing and substantially conforming to the major surface of the tool and comprising the plurality of alternating first ridges and first grooves.

In some embodiments, the step of removing the temporary carrier from the first major surface of the inorganic layer may include removing the temporary carrier by plasma etching, wet etching, solvent dissolution, laser ablation, chemo-mechanical polishing (CMP), or any other appropriate method.

In some embodiments, the temporary carrier may include a carrier substrate having a separable release layer where the major structured surface is deposited on the separable release layer. Examples of a carrier having a separable release layer are described in co-pending U.S. Patent Application No. 63/265,650 filed on Dec. 17, 2021.

In such embodiments, the step of removing the temporary carrier involves removing the carrier substrate and then removing the remaining “major structured surface” by plasma etching, wet etching, solvent dissolution, laser ablation, chemo-mechanical polishing (CMP), or any other appropriate method.

According to some aspects of the present description, an optical waveguide may include an optical core configured to propagate an image light therealong; and first and second multilayer gratings disposed on the optical core. In some embodiments, the first multilayer grating may be configured to receive an image light from an image projector and to inject at least a portion of the received image light into the optical core. In some embodiments, the injected image light may propagate along the optical core primarily by total internal reflection. In some embodiments, the second multilayer grating may be configured to receive at least a portion of the injected image light and extract at least a portion of the received injected image light from the optical core for viewing by a viewer (e.g., a human observer). In some embodiments, the first and second multilayer gratings may have different width directions (e.g., the x axes relative to each multilayer grating may define a non-zero angle therebetween if overlaid). In some embodiments, the optical core may have an index of refraction of greater than about 1.5, or greater than about 1.6, or greater than about 1.7, or greater than about 1.8, or greater than about 1.9, or greater than about 2.0 at a wavelength of about 580 nm. In some embodiments, the optical core may include one or more of tantalum, niobium, lanthanum, lead, barium, titanium, zirconium, and bismuth. In some embodiments, the optical core may be a polymer. In some embodiments the optical core may include one or more of polymethacrylate, polycarbonate, polyester, polyphosphonate, polysulfone, silicone, epoxy, or polyimide constituents. In some embodiments, the optical core may include nanoparticles. In some embodiments, the optical core may include nanoparticles of titania, or zirconia. In some embodiments, each of the first and second multilayer gratings may include an inorganic undulating layer and a planarizing adhesive layer. In some embodiments, the inorganic undulating layer may include opposing outermost undulating major surfaces nestingly aligned with each other to have a wave-like shape along a width direction (e.g., along an x-axis) of the inorganic undulating layer and forming a plurality of substantially parallel ridges and grooves. In some embodiments, the ridges and the grooves may extend along an orthogonal length direction (e.g., a y-axis) of the inorganic undulating layer. In some embodiments, an undulation amplitude of at least one of the first and second multilayer gratings may vary along the width direction thereof.

As used herein, the phrase “undulating layer” refers to the layer having a wave-like pattern, shape, or profile in the width direction of the layer with successive curves in the layer in alternate directions forming alternating peaks and valleys, or ridges and grooves, on each major side of the layer along the width direction and extending along the length direction of the layer. Examples of undulating layers include, but are not limited to, a layer having a sinusoidal wave pattern, shape, or profile, and a layers having a triangular wave, slanted, or blazed pattern, shape, or profile. Other examples of undulating layers include layers featuring a two-dimensional (2D) pattern of posts and/or holes, where a cross-section taken through a linear collection (e.g., a row) of posts or holes creates an undulating pattern across the layer.

In some embodiments, the planarizing adhesive layer may be disposed between the inorganic undulating layer and the optical core and substantially planarizing one of the undulating major surfaces of the inorganic undulating layer and bonding the inorganic undulating layer to the optical core.

In some embodiments, the planarizing adhesive layer may define a minimum distance dₘᵢₙ between the inorganic undulating layer and the optical core. In some such embodiments, dₘᵢₙ may be greater than about 5 nm, or about 10 nm, or about 15 nm, or about 20 nm, or about 25 nm, or about 30 nm, or about 35 nm, or about 40 nm, or about 45 nm, or about 50 nm. In some embodiments, for at least one of the first and second multilayer gratings, a minimum separation between the optical core and the grooves of the multilayer gratings may change along the width of the multilayer grating.

In some embodiments, for at least one of the first and second multilayer gratings, in a planar cross-section (e.g., an xz-plane) of the multilayer grating that is orthogonal to the length direction (e.g., a y-axis) of the multilayer gratings, for two different locations on the multilayer grating L1 and L2, each location including one ridge and one directly adjacent groove, where the area between the optical core and the ridge at L1 is Aᵣ₁, the area between the optical core and the groove at L1 is A_{g1}, the area between the optical core and the ridge at L2 is Aᵣ₂, and the area between the optical core and the groove at L2 is A_{g2}, Aᵣ₁+A_{g1} is within 30% of Aᵣ₂+A_{g2}, or within 20%, or within 10%, or within 5%, or within 2%.

In some embodiments, for at least one of the first and second multilayer gratings, the multilayer grating further may include a planarizing cover layer conformally covering the inorganic undulating layer opposite the planarizing adhesive layer and substantially planarizing the inorganic undulating layer. In some embodiments, the first and second multilayer gratings may be disposed on the same side of the optical core, or may be disposed on opposite major sides of the optical core. In some embodiments, the first and second multilayer gratings may be spaced apart, while in other embodiments, the first and second multilayer gratings may be in contact or overlap.

In some embodiments, the optical waveguide may further include a connecting adhesive portion disposed between, and continuously and seamlessly connecting, the planarizing adhesive layers of the first and second multilayer gratings. In some embodiments, the optical waveguide may further include a connecting substantially non-undulating inorganic layer disposed between, and continuously and seamlessly connecting, the inorganic undulating layers of the first and second multilayer gratings.

In some embodiments, each of the first and second multilayer gratings may further include a planarizing cover layer conformally covering the inorganic undulating layer opposite the planarizing adhesive layer and substantially planarizing the inorganic undulating layer. In some such embodiments, the optical waveguide may further include a substantially planar connecting cover layer disposed between, and continuously and seamlessly connecting, the planarizing cover layers of the first and second multilayer gratings.

In some embodiments, for at least one visible wavelength in a human-visible wavelength range extending from about 420 nm to about 680 nm, an index of refraction of the planarizing cover layer is less than the index of refraction of the inorganic undulating layer by at least 0.5, or at least 0.6, or at least 0.7, or at least 0.8, or at least 0.9, or at least 1.0, or at least 1.2.

In some embodiments, for at least one of the first and second multilayer gratings, the plurality of substantially parallel ridges and grooves may form a periodic pattern along the width direction of the inorganic undulating layer. In some such embodiments, the periodic pattern may have a period in a range from about 100 nm to about 1000 nm, or from about 150 nm to about 750 nm, or from about 200 nm to about 700 nm, or from about 250 nm to about 600 nm, or from about 300 nm to about 550 nm, or from about 300 nm to about 500 nm, or from about 300 nm to about 450 nm.

In some embodiments, the optical core may have an average thickness of between about 100 microns and about 2000 microns, or about 150 microns and about 1500 microns, or about 200 microns and about 1250 microns, or about 250 microns and about 1250 microns, or about 300 microns and about 1000 microns. In some embodiments the optical core may have a thickness of up to 5000 microns, or up to 7500 microns, or up to 10,000 microns. In some embodiments, a minimum thickness of the planarizing adhesive layer may be greater than about 5 nm, or about 10 nm, or about 15 nm, or about 20 nm, or about 25 nm, or about 30 nm, or about 35 nm, or about 40 nm, or about 45 nm, or about 50 nm.

In some embodiments, the inorganic undulating layer may include one or more of titanium dioxide (TiO₂), zirconium oxide (ZrOₓ), titanium oxide (TiOₓ), SiO₂, Al₂O₃, CeO₂, ZnO, Nb₂O₅, Ta₂O₅, HfO₂, SiAlOₓN_{y}, Si₃N₄, Nb-doped TiO₂, and zirconium dioxide (ZrO₂).

In some embodiments, an optical system may include any of the optical waveguides described herein, and the image projector configured to emit the image light, wherein the first multilayer grating may be configured to receive the emitted image light and inject at least a portion of the received image light into the optical core of the optical waveguide.

In some embodiments, for at least one visible wavelength in a visible wavelength range extending from about 420 nm to about 680 nm, the planarizing adhesive layer may have an index of refraction of between about 1.35 to about 2.5. In some embodiments, for at least one visible wavelength in a visible wavelength range extending from about 420 nm to about 680 nm, the planarizing adhesive layer may have an index of refraction of about 1.5. In some embodiments, the inorganic undulating layer may have an index of refraction of greater than about 1.5, or greater than about 1.6, or greater than about 1.7, or greater than about 1.8, or greater than about 1.9, or greater than about 2.0, or greater than about 2.1, or greater than about 2.2, or greater than about 2.3, or greater than about 2.4 at a wavelength of about 580 nm.

In some embodiments, a minimum spacing between the optical core and the plurality of substantially parallel ridges and grooves may be greater than about 5 nm, or about 10 nm, or about 15 nm, or about 20 nm, or about 25 nm, or about 30 nm, or about 35 nm, or about 40 nm, or about 45 nm, or about 50 nm. In some embodiments, as average spacing between the grooves and the optical core may be less than about 500 nm, or about 450 nm, or about 400 nm, or about 350 nm, or about 300 nm, or about 250 nm, or about 200 nm, or about 150 nm, or about 100 nm.

According to some aspects of the present description, an optical waveguide may include an optical core configured to propagate an image light therealong, and a continuous seamless multilayer disposed on a major side of the optical core.

In some embodiments, the continuous seamless multilayer may include a continuous seamless inorganic layer and a continuous seamless adhesive layer. In some embodiments, the continuous seamless inorganic layer may undulate in a plurality of discrete spaced apart regions of the inorganic layer to form a plurality of spaced apart undulated inorganic layer portions of an otherwise non-undulated inorganic layer.

In some embodiments, each of the undulated inorganic layer portions may include opposing outermost undulating major surfaces nestingly aligned with each other and forming a plurality of substantially parallel ridges and grooves of the undulated inorganic layer portion extending along a length-direction (e.g., a x-axis) of the undulated inorganic layer portion and arranged along an orthogonal width-direction (e.g., a y-axis) of the undulated inorganic layer portion.

In some embodiments, the continuous seamless adhesive layer may be disposed between the inorganic layer and the optical core and may substantially conform to the ridges and grooves of each of the undulated inorganic layer portion and bonding the inorganic layer to the optical core.

In some embodiments, a first of the undulated inorganic layer portions is configured to receive an image light from an image projector and inject at least a portion of the received image light into the optical core. In some embodiments, the injected image light may propagate along the optical core primarily by total internal reflection. In some embodiments, a second of the undulated inorganic layer portions may be configured to receive at least a portion of the injected image light along a first direction and redirect the injected image light as a redirected image light propagating along a different, second direction along the optical core primarily by total internal reflection. In some embodiments, a third of the undulated inorganic layer portions may be configured to receive at least a portion of the redirected image light and extract at least a portion of the received redirected image light from the optical core for viewing by a viewer.

When used herein, the term “seamless” used in conjunction with the term “layer” (as in “seamless adhesive layer”) shall be defined to mean a layer which was formed as a continuous piece and which substantially does not contain gaps within the layer. In some embodiments, a “seamless” layer may contain small cracks (e.g., cracks formed unintentionally as a result of a manufacturing or processing step) which do not significantly affect the intended function of the otherwise continuous layer. In addition, a layer containing intentional discontinuities between two substantially similar sections of the layer, wherein the two sections are otherwise in direct contact with each other (e.g., a butt-joint between two sections) and wherein the layer otherwise functionally performs substantially as a continuous layer, shall be considered seamless.

According to some aspects of the present description, a method of making an optical waveguide may include the steps of providing a temporary carrier including a major structured surface having, in a plurality of discrete spaced apart regions, a plurality of alternating first ridges and first grooves: conformally disposing an inorganic layer on the major structured surface of the temporary carrier so that both a first major surface thereof facing the temporary carrier and a second major surface thereof facing away from the carrier substantially conform to the major structured top surface of the temporary carrier to form a continuous seamless inorganic layer having a plurality of undulated inorganic layer portions in an otherwise non-undulated inorganic layer, such that in each of the undulated inorganic layer portions, the first and second major surfaces of the layer portion define a spacing average S_{avg} and a spacing standard of deviation S_{sd} therebetween, S_{sd}/S_{avg} less than about 0.5, or less than about 0.4, or less than about 0.3, or less than about 0.2, or less than about 0.17, or less than about 0.15, or less than about 0.12, or less than about 0.1; substantially conformally coating the second major surface of the inorganic with an adhesive layer and substantially planarizing the inorganic layer to form a structured adhesive layer having a major structured top surface facing and substantially conforming to the second major surface of the inorganic layer and an opposing substantially planar major surface; adhering the substantially planar major surface of the structured adhesive layer to a major surface of an optical core configured to propagate an image light therealong primarily by total internal reflection; and removing the temporary carrier from the first major surface of the inorganic layer.

Turning now to the figures. FIGS. 1A and 1B include side views of an embodiment of an optical waveguide according to the present description. In FIG. 1A, an embodiment of an optical system 300 is shown. In some embodiments, optical system 300 includes an optical waveguide 200 and at least one light source 70/71.

In some embodiments, optical waveguide 200 includes an optical core 30 and a multilayer grating 40. In some embodiments, multilayer grating 40 may be disposed on optical core 30 and configured to extract an optical mode that would otherwise propagate along optical core 30.

In some embodiments, light source 70/71 may be disposed so as to inject light 20/21 at a first wavelength in a human-visible (visible) wavelength range into optical core 30, where the injected light 20/21 propagates along optical core 30 along a first direction (e.g., a direction along the x-axis, as shown in FIG. 1A) of the optical core 30 as the optical mode. Light 20/21 propagates along optical core 30 until it impinges on multilayer grating 40, where it may pass into multilayer grating 40 and be extracted from optical core 30 (where it may be viewed by a viewer, not shown in FIG. 1A, but shown elsewhere herein). It should be noted that the first wavelength may also be outside of the visible wavelength range (e.g., may be an infrared wavelength).

In some embodiments, multilayer grating 40 may include an adhesive layer 50 and an inorganic layer 60. In some embodiments, adhesive layer 50 may include a major bottom surface 51 facing optical core 30 and an opposing structured major top surface 52 facing away and spaced apart from optical core 30. In some embodiments, the structured major top surface 52 may include a plurality of substantially parallel linear grating elements 53 extending along a same length direction (e.g., the y-axis as shown in FIG. 1A) of the grating elements 53 and arranged along an orthogonal width direction (e.g., the x-axis as shown in FIG. 1A) of the grating elements 53.

In some embodiments, the plurality of substantially parallel linear grating elements 53 form a periodic pattern along the width direction (e.g., the x-direction shown in FIG. 1A) of the grating elements 53. In some embodiments, the width direction of the grating elements is substantially parallel to the first direction. In some such embodiments, the periodic pattern may have a period in a range from about 100 nm to about 1000 nm, or from about 150 nm to about 750 nm, or from about 200 nm to about 700 nm, or from about 250 nm to about 600 nm, or from about 300 nm to about 550 nm, or from about 300 nm to about 500 nm, or from about 300 nm to about 450 nm.

In some embodiments, the optical core may have an average thickness the of between about 100 microns and about 2000 microns, or about 150 microns and about 1500 microns, or about 200 microns and about 1250 microns, or about 250 microns and about 1250 microns, or about 300 microns and about 1000 microns. In some embodiments, a minimum spacing, d_{b}, between the optical core and the major top surface of the adhesive layer is greater than about 5 nm, or greater than about 10 nm, or greater than about 15 nm, or greater than about 20 nm, or greater than about 25 nm, or greater than about 30 nm, or greater than about 35 nm, or greater than about 40 nm, or greater than about 45 nm, or greater than about 50 nm.

In some embodiments, the inorganic layer 60 may be disposed on and may conform to the structured major top surface 52 of adhesive layer 50 so that the inorganic layer 60 has a thickness standard deviation that is less than about 50%, or about 45%, or about 40%, or about 35%, or about 30%, or about 25%, or about 20% of an average thickness of the inorganic layer 60. In some embodiments, inorganic layer 60 may have a first major surface 61 facing away from optical core 30 and a second major surface 62 facing toward optical core 30 and substantially conforming to the major structured top surface 52 of adhesive layer 50. In some embodiments, inorganic layer 60 may define a plurality of alternating first concavities 63 and second concavities 64, wherein the first concavities 63 are concave toward the optical core 30 and the second concavities 64 are convex toward optical core 30. In some embodiments, inorganic layer 60 may include one or more of titanium dioxide (TiO₂), zirconium oxide (ZrOₓ), titanium oxide (TiOₓ), SiO₂, Al₂O₃, CeO₂, ZnO, Nb₂O₅, Ta₂O₅, HfO₂, SiAlOₓN_{y}, Si₃N₄, Nb-doped TiO₂, and zirconium dioxide (ZrO₂).

In some embodiments, the multilayer grating 40 of the optical waveguide 200 may further include a cover layer 80 disposed on and substantially planarizing the inorganic layer 60. In some embodiments, at the first wavelength, an index of refraction of the cover layer 80 may be less than the index of refraction of the inorganic layer 60 by at least 0.5.

FIG. 1B shows additional detail on adhesive layer 50. Adhesive layer 50 may be structured and include a major bottom surface 51 and an opposing major structured top surface 52. In some embodiments, major structured top surface 52 may include a plurality of alternating ridges 54 and grooves 55. In some embodiments, an average spacing da between the bottoms of grooves 55 and the optical core 30 may be greater than about 5 nm, or about 10, or about 15, or about 20, or about 25, or about 30, or about 35, or about 40, or about 45, or about 50 nm.

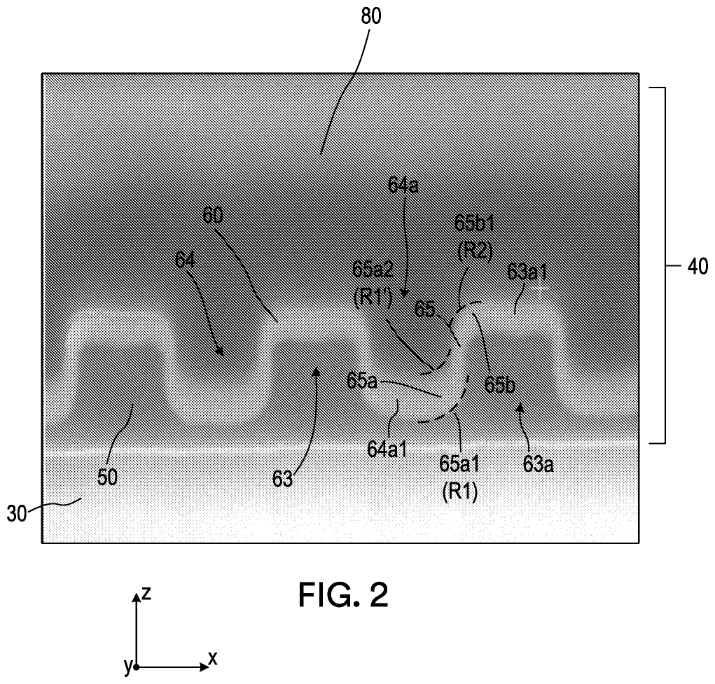

FIG. 2 is an image from a scanning electron microscope (SEM) of a multilayer grating on an optical core, according to an embodiment of the present description. A multilayer grating 40 is disposed on an optical core 30. In the embodiment shown in FIG. 2, the multilayer grating 40 includes an adhesive layer 50, an inorganic layer 60 conforming to the adhesive layer 50, and a cover layer 80 planarizing the top of the multilayer grating 40.

Inorganic layer 60 is disposed on optical core 30 and defines a plurality of alternating first 63 and second 64 concavities. In this embodiment, first concavities 63 are concave toward optical core 30, the second concavities 64 are convex toward optical core 30. Structured adhesive layer 50 is disposed between and bonding optical core 30 to inorganic layer 60 such that the structured adhesive layer 50 substantially fills first concavities 63.

For each pair of adjacent first concavities 63a and second concavities 64a, the first 63a and second 64a concavities are separated by a common side wall 65 extending from a first rounded side wall corner 65a joining the common side wall 65 to a bottom 64al of the second concavity 64a to an opposite second rounded side wall corner 65b1 joining the common side wall 65 to a bottom 63al of first concavity 63a.

In a first planar cross-section (e.g., the xz-plane shown in FIG. 2) substantially orthogonal to the common side wall 65, the first rounded side wall corner 65a includes an outer first circumferential surface 65al which faces the optical core 30 and has a first radius of curvature R1, and the second rounded side wall corner 65b includes an outer second circumferential surface 65b1 facing away from optical core 30 and having a second radius of curvature R2, such that R1 is greater than R2 for at least a plurality of pairs of adjacent first 63a and second 64a concavities.

Also, in the same first planar cross-section (i.e., the xz-plane), the first rounded side wall corner 65a has an inner first circumferential surface 65a2 facing away from the optical core and having a first inner radius of curvature R1′, such that R1 is greater than R1′ for at least a plurality of pairs of adjacent first 63a and second 64a concavities.

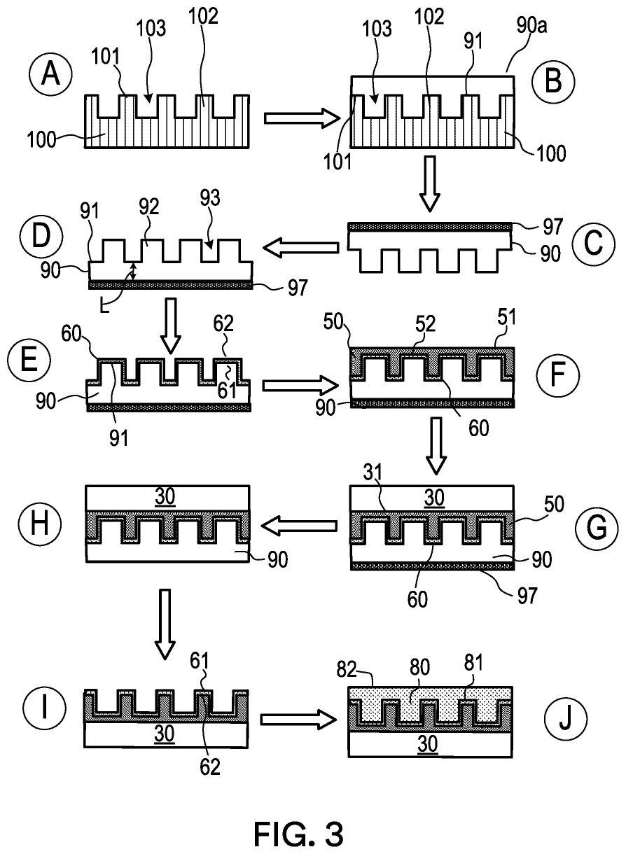

FIG. 3 is a process flow illustrating one embodiment of a method of making an optical waveguide with multilayer grating according to the present description. The method may include steps A-J outlined herein. It should be noted that the flow of the process shown in FIG. 3 follows the arrows provided between steps in FIG. 3 and moves in a serpentine pattern from the top of FIG. 3 to the bottom of FIG. 3 (i.e., the steps are performed in order based on their alphabetical labels from Step A to Step J).

A temporary carrier 90 with a major structured surface 91 having a plurality of alternating first ridges 92 and first grooves 93 is provided (Step D). In some embodiments. Step D may include providing a tool 100 having a major structured surface 101 having a plurality of alternating ridges 102 and grooves 103 (Step A), disposing a temporary carrier material 90a on the major structured surface 101 of tool 100 to form a temporary carrier 90 having a major structured surface 91 facing and substantially conforming to the major structured surface 101 of tool 100 and including the plurality of alternating first ridges 92 and first grooves 93 (Step B), removing the temporary carrier 90 from tool 100 (Step C). In some embodiments, temporary carrier 90 may include a separable substrate 97 for handling and/or transferring. In some embodiments, the land area (marked as L in Step D, representing the thickness between the bottom of one groove on the major structured surface 91 and the opposing surface of the temporary carrier) may be less than 10 microns, or less than 5 microns, or less than 2 microns, or less than 1 micron, or less than 0.5 microns thick.

In Step E, an inorganic layer 60 is conformally disposed on major structured surface 91 of temporary carrier 90 so that both a first major surface 61 thereof facing temporary carrier 90 and a second major surface 62 thereof facing away from carrier 90 substantially conform to the major structured top surface 91 of the temporary carrier 90. In some embodiments, the first major surface 61 and the second major surface 62 of the inorganic layer 60 may define a spacing average S_{avg} and a spacing standard of deviation S_{sd} therebetween, such that S_{sd}/S_{avg} is less than about 0.5, or about 0.4, or about 0.3, or about 0.2, or about 0.17, or about 0.15, or about 0.12, or about 0.1. In some embodiments, suitable deposition methods may include a chemical vapor deposition (CVD) method, a sputter coating method, a physical vapor deposition (PVD) method, an atomic layer deposition (ALD) method, or any appropriate combination thereof.

In Step F, a layer of adhesive material is disposed on the second major surface 62 of inorganic layer 60 which substantially planarizes inorganic layer 60 to form a structured adhesive layer 50 having major structured top surface 52 which faces and substantially conforms to second major surface 62 of inorganic layer 60, and an opposing substantially planar major surface 51.

In some embodiments, the layer of adhesive material may be a polymeric or monomeric adhesive layer and/or may be an optically clear adhesive layer. Suitable optically clear adhesives include, but are not limited to, those available from Norland Products, Inc. (Cranbury, NJ), for example. Other suitable adhesives include thermosetting materials such as those available from the Dow Chemical Company (Midland, MI) under the CYCLOTENE tradename, for example. Still other suitable adhesives include heat-activated adhesives such as those available from KRATON Polymers (Huston, TX) under the KRATON tradename, for example. Suitable adhesive layers, including thin adhesive layers (e.g., less than 50 nm thick), are described in U.S. Pat. No. 7,521,727 (Khanarian et al.); U.S. Pat. No. 7,53,419 (Camras et al.); U.S. Pat. No. 6,709,883 (Yang et al.); and U.S. Pat. No. 6,682,950 (Yang et al.), for example.

In Step G, the substantially planar major surface 51 of the structured adhesive layer 50 is adhered to a major surface 31 of an optical core 30 configured to propagate an image light therealong primarily by total internal reflection. In Step H, the separable substrate, if present, is removed from temporary carrier 90. In Step I, temporary carrier 90 is removed from the first major surface 61 of inorganic layer 60.

In some embodiments, a cover material may be disposed on the first major surface 61 of inorganic layer 60 to substantially planarizing inorganic layer 60 to form a structured cover layer 80 (Step J). In some embodiments, structured cover layer 80 may have a major structured surface 81 facing and substantially conforming to first major surface 61 of inorganic layer 60 and an opposing substantially planar major surface 82.

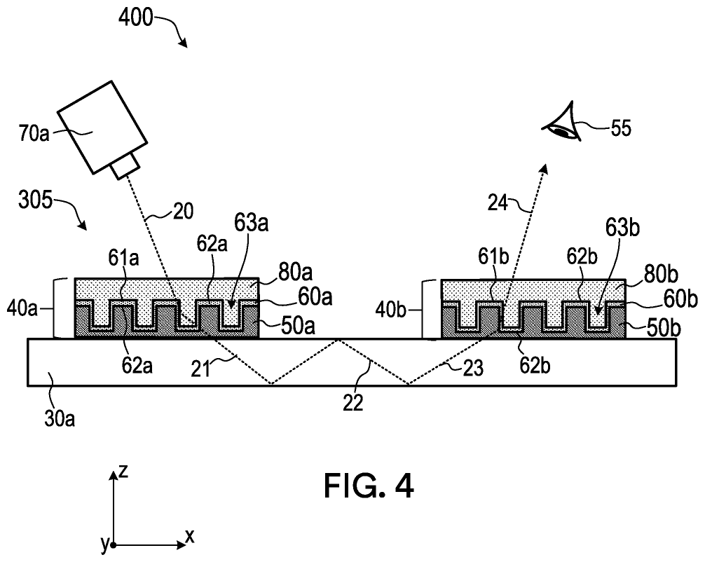

FIG. 4 is a side view of an embodiment of optical system having an optical waveguide featuring at least first and second microlayer gratings, according to the present description. In some embodiments, optical system 400 includes an optical waveguide 305 (including a first multilayer grating 40a, a second multilayer grating 40b, and an optical core 30a), and an image projector 70a.

In some embodiments, optical core 30a of optical waveguide 305 may be configured to propagate light therealong through total internal reflection. In some embodiments, first 40a and second 40b spaced-apart, multilayer gratings are disposed on optical core 30a, In some embodiments, first multilayer grating 40a may be configured to receive image light 20 from image projector 70a and inject at least a portion 21 of the received image light into optical core 30a.

In some embodiments, the injected image light 21 propagates along the optical core as propagating image light 22 primarily by total internal reflection. In some embodiments, second multilayer grating 40b may be configured to receive at least a portion 23 of the propagating image light 22 and extract at least a portion 24 of the received injected image light from optical core 30a for viewing by a viewer 55.

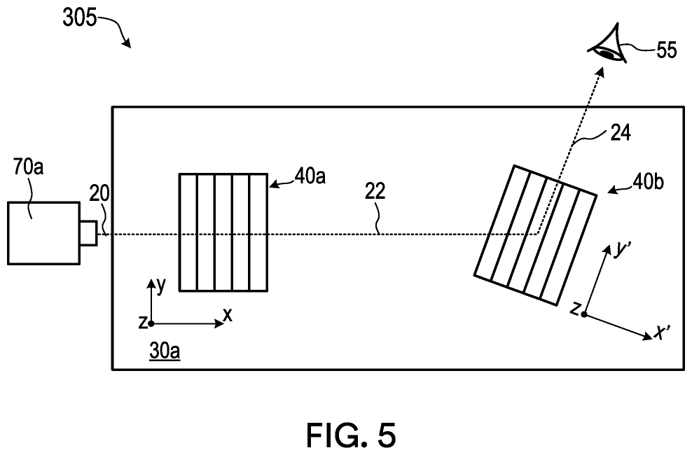

In some embodiments, each of the first 40a and second 40b multilayer gratings may include an inorganic undulating layer 60a, 60b and a planarizing adhesive layer 50a, 50b. In some embodiments, inorganic undulating layer 60a, 60b may include opposing outermost undulating major surfaces 61a, 61b, 62a, 62b nestingly aligned with each other to have a wave-like shape along a width direction (e.g., the x-axis as shown in FIG. 4 for 40a, or x′ axis shown in FIG. 5 for 40b) of the inorganic undulating layer 60a, 60b, and forming a plurality of substantially parallel ridges 62a, 62b and grooves 63b, 63b. In some embodiments, ridges 62a, 62b and grooves 63b, 63b extend along an orthogonal length direction (e.g., the y-axis of FIG. 4, or the y′-axis of FIG. 5) of the inorganic undulating layers 60a, 60b.

In some embodiments, planarizing adhesive layer 50a, 50b may be disposed between inorganic undulating layer 60a, 60b and optical core 30a and may substantially planarize one of the undulating major surfaces 62a, 62b of inorganic undulating layer 60a, 60b and bonding the inorganic undulating layer 60a, 60b to optical core 30a.

In some embodiments, for at least one of the first 40a and second 40b multilayer gratings, the multilayer grating may further include a planarizing cover layer 80a, 80b conformally covering inorganic undulating layer 60a, 60b opposite the planarizing adhesive layer 50a, 50b and substantially planarizing the inorganic undulating layer 60a, 60b.

FIG. 5 provides an alternate view of the embodiment of the optical waveguide of FIG. 4. Like-numbered components common to both FIGS. 4 and 5 shall be assumed to serve similar functions unless specifically stated otherwise. That is, descriptions given for components in FIG. 4 shall be assumed to apply to like-numbered components in FIG. 5 and therefore these descriptions may not be repeated in the description of FIG. 5. In some embodiments, image light 20 is emitted by image projector 70a and enters optical core 30 via first multilayer grating 40a, This image light is propagated as propagating image light 22 (via total internal reflection within optical core 30a) until at least a portion of the light is extracted from optical core 30a via second multilayer grating 40b as extracted image light 24 for viewing by viewer 55. As shown in FIG. 5, the orientation of first multilayer grating 40a and second multilayer grating 40b (i.e., the width directions of the two gratings) may differ, as may be required by an application to direct the image light in an appropriate direction. In some embodiments, the ridges and grooves of first multilayer grating 40a may be aligned with and extend in the x direction shown in FIG. 5 (left side of FIG. 5), while the ridges and grooves of second multilayer grating 40b may be aligned with and extend in the x′ direction shown in FIG. 5 (right side of FIG. 5).

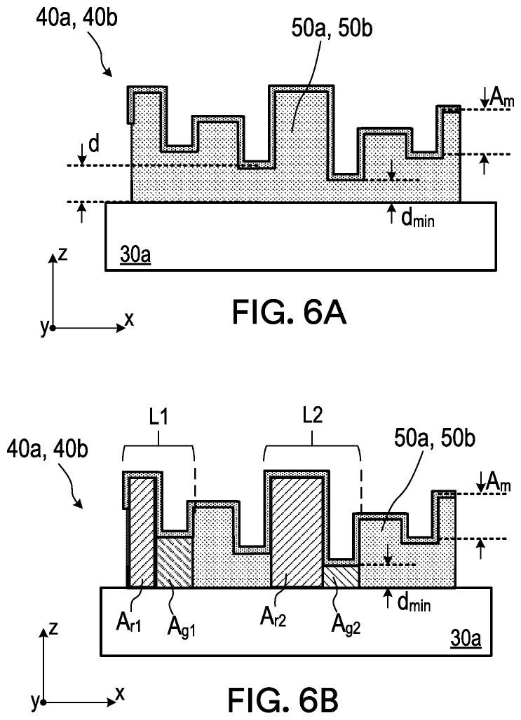

FIGS. 6A and 6B include side views of the architecture of an embodiment of a multilayer grating, such as multilayer gratings 40a, 40b of FIGS. 4 and 5. FIGS. 6A and 6B may be examined together for the following discussion. In some embodiments, at least one of multilayer gratings 40a, 40b may have an undulation amplitude Aₘ (e.g., the distance between the bottom of a groove to the top of an adjacent ridge) that varies along the width direction (e.g., the x-direction shown in FIGS. 6A-6B) thereof. In some embodiments, the planarizing adhesive layer 50a, 50b may define a minimum distance dₘᵢₙ between the inorganic undulating layer 60 and the optical core 30a, such that dₘᵢₙ is greater than about 5 nm, or about 10 nm, or about 15 nm, or about 20 nm, or about 25 nm, or about 30 nm, or about 35 nm, or about 40 nm, or about 45 nm, or about 50 nm. In some embodiments, for at least one of the first 40a and second 40b multilayer gratings, a minimum separation d between the optical core 30a and the bottom of the grooves of the multilayer gratings 40a, 40b may change along the width of the multilayer grating 40a, 40b.

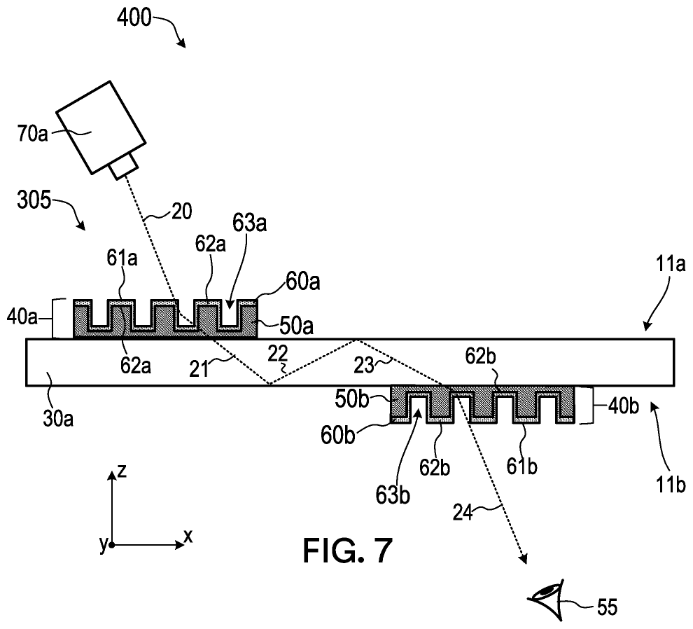

In some embodiments, for at least one of the first 40a and second 40b multilayer gratings, in a planar cross-section (e.g., the xz-plane shown in FIGS. 6A-6B) of the multilayer grating 40a. 40b that is orthogonal to the length direction (e.g., the y-axis) of the multilayer gratings 40a, 40b, and for two different locations on the multilayer grating L1 and L2, each location including a single ridge and a single directly adjacent groove, where the area between the optical core and the ridge at L1 is Aᵣ₁, the area between the optical core and the groove at L1 is A_{g1}, the area between the optical core and the ridge at L2 is Aᵣ₂, and the area between the optical core and the groove at L2 is A_{g2}, Aᵣ₁+A_{g1} is within 30% of Aᵣ₂+A_{g2}, or within 30% of Aᵣ₂+A_{g2}, or within 10% of Aᵣ₂+A_{g2}, or within 5% of Aᵣ₂+A_{g2}, or within 2% of Aᵣ₂+A_{g2}. FIG. 7 is a side view of an alternate embodiment of an optical system, including an optical waveguide with first and second multilayer gratings disposed on opposite side of an optical core. The embodiment shown in FIG. 7 is similar to the embodiment shown in FIG. 4 discussed elsewhere herein. Accordingly, like-numbered components common to both figures shall be assumed to have the same function unless specifically stated otherwise, and definitions may not be repeated from the discussion of FIG. 4 in the discussion of FIG. 7. In the embodiment of FIG. 7, the first 40a and second 40b spaced-apart, multilayer gratings are disposed on opposite major sides 11a and 11b of the optical core 30a (as opposed to on the same major side, as shown in FIG. 4). The basic function of optical waveguide 305 of FIG. 7 is essentially the same as the basic function of optical waveguide 305 of FIG. 4 (i.e., the second multilayer grating 40b extracts a portion of light 23 and directs it as image light 24 for viewing by viewer 55, but viewer 55 is now on major side 11b of optical waveguide 305, and image projector 70a is on side 11a of optical waveguide 305).

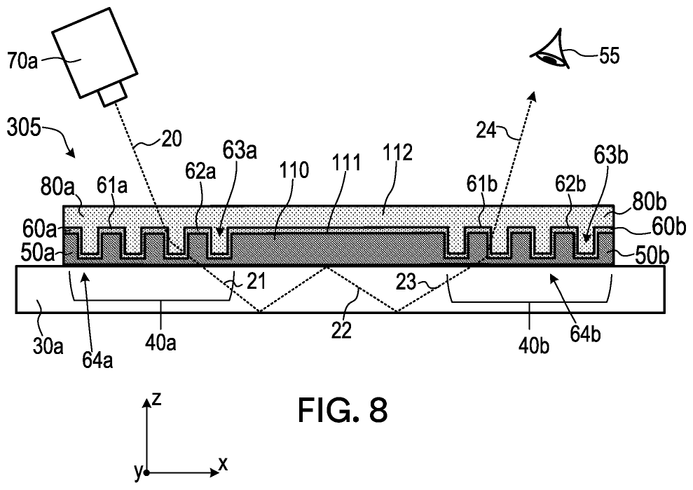

FIG. 8 is a side view of another alternate embodiment of optical waveguide 305, and also shares common, like-numbered components with both FIGS. 4 and 7, which shall be assumed to have similar functions unless specifically stated otherwise. In the embodiment of optical waveguide 305 of FIG. 8, the optical waveguide 305 further includes a connecting adhesive portion 110 disposed between, and continuously and seamlessly connecting, the planarizing adhesive layers 50a, 50b of the first 40a and second 40b multilayer gratings. In some embodiments, optical waveguide 305 further includes a connecting, substantially non-undulating inorganic layer 111 disposed between, and continuously and seamlessly connecting, the inorganic undulating layers 60a, 60b of the first 40a and second 40b multilayer gratings. In some embodiments, wherein each of the first 40a and second 40b multilayer gratings further includes a planarizing cover layer 80a, 80b conformally covering the inorganic undulating layer 60a, 60b opposite the planarizing adhesive layer 50a, 50b and substantially planarizing the inorganic undulating layer 60a, 60b, the optical waveguide 305 may further include a substantially planar connecting cover layer 112 disposed between, and continuously and seamlessly connecting, the planarizing cover layers 80a, 80b of the first 40a and second 40b multilayer gratings. In some such embodiments, for at least one visible wavelength in a human-visible wavelength range extending from about 420 nm to about 680 nm, an index of refraction of the planarizing cover layer 112, 80a, 80b may be less than index of refraction of the inorganic undulating layer 60a, 60b by at least 0.5.

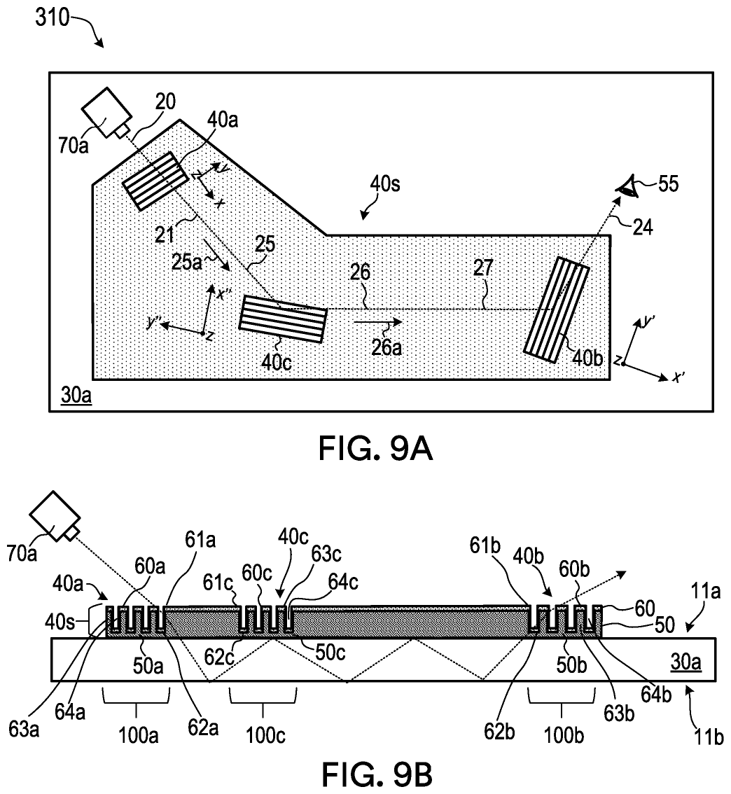

FIGS. 9A and 9B provide top and side views, respectively, of yet another embodiment of an optical waveguide. FIGS. 9A and 9B should be examined together for the following discussion. In some embodiments, optical waveguide 310 may include an optical core 30a configured to propagate an image light therealong and a continuous seamless multilayer 40s disposed on a major side 11a of optical core 30a, In some embodiments, continuous seamless multilayer 40s may include a continuous seamless inorganic layer 60 and a continuous seamless adhesive layer 50.

In some embodiments, continuous seamless inorganic layer 60 may be undulated in a plurality of discrete spaced apart regions 100a, 100b, 100c (FIG. 9B) of the inorganic layer 60 to form a plurality of spaced apart undulated inorganic layer portions 60a, 60b, 60c of an otherwise non-undulated inorganic layer 60. In some embodiments, each of the undulated inorganic layer portions 60a, 60b, 60c may include opposing outermost undulating major surfaces 61a, 61b, 61c; 62a, 62b, 62c nestingly aligned with each other and forming a plurality of substantially parallel ridges 63a, 63b, 63c and grooves 64a, 64b, 64c of the undulated inorganic layer portion 60a, 60b, 60c extending along a length-direction (see, e.g., y-, y′-, and y″-axis depictions in FIG. 9A) of the undulated inorganic layer portion 60a, 60b, 60c and arranged along an orthogonal width-direction (e.g., y-, y′-, and y″-axis) of the undulated inorganic layer portion 60a, 60b, 60c.

In some embodiments, the continuous seamless adhesive layer 50 may be disposed between the inorganic layer 60 and the optical core 30a and may substantially conform to the ridges 63 and grooves 64 of each of the undulated inorganic layer portions 60a, 60b, 60c and bonding the inorganic layer 60 to the optical core 30a.

In some embodiments, a first undulated inorganic layer portion 40a may be configured to receive an image light 20 from an image projector 70a and inject at least a portion 21 of the received image light into optical core 30a, In some embodiments, the injected image light 21 may propagate along optical core 30a primarily by total internal reflection.

In some embodiments, a second undulated inorganic layer portion 40c may be configured to receive at least a portion 25 of the injected image light 21 along a first direction 25a and redirect the injected image light as a redirected image light 26 propagating along a different second direction 26a along the optical core 30a primarily by total internal reflection.

In some embodiments, a third undulated inorganic layer portion 40b may be configured to receive at least a portion 27 of the redirected image light and extract at least a portion 24 of the received redirected image light from the optical core 30a for viewing by a viewer 55.

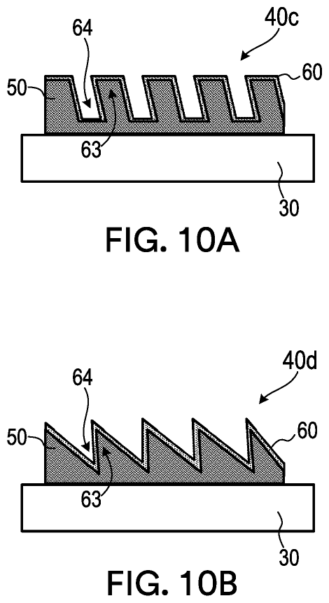

FIGS. 10A and 10B provide illustrative examples of alternative shapes for the features on a multilayer grating. FIG. 10A shows a multilayer grating 40c disposed on an optical core 30. In some embodiments, multilayer grating 40c may include an adhesive layer 50 and an inorganic layer 60. In some embodiments, inorganic layer 60 may define a plurality of alternating first concavities 63 and second concavities 64, wherein the first concavities 63 are concave toward the optical core 30 and the second concavities 64 are convex toward optical core 30. In the embodiment 40c of FIG. 10A, the first concavities 63 and second concavities 64 may have a slanted square wave shape. In FIG. 10B, the plurality of alternating first concavities 63 and second concavities 64 of multilayer grating 40d may have a triangular or “blazed” shape.

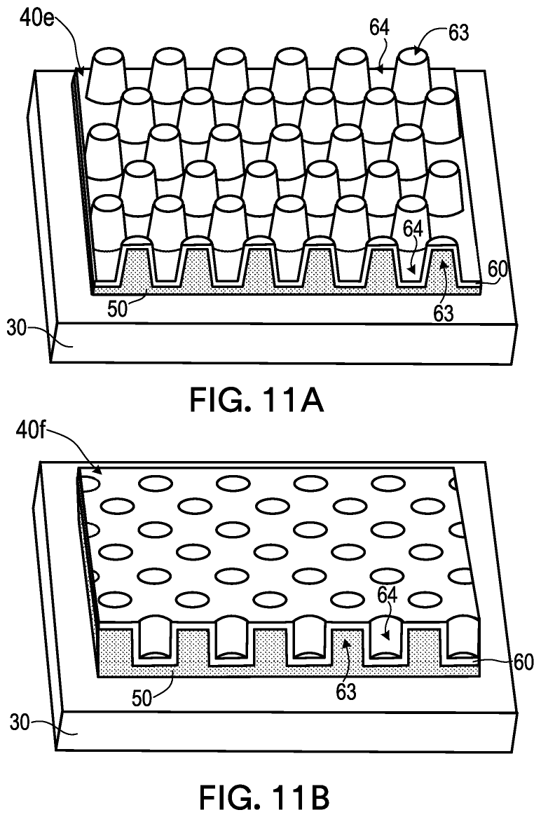

Although the examples discussed herein thus far have demonstrated a one-dimensional pattern of undulations, multilayer gratings exhibiting a two-dimensional array of features are also within the scope of the present description. For example. FIG. 11A shows an example of a grating 40e which exhibits a two-dimensional array of posts, comparable to ridges 63, with the area between the posts comparable to grooves 64. Similarly. FIG. 11B shows a grating 40f with a two-dimensional array of holes, where each hole is similar in function to a groove 64 and the area between holes is comparable to ridges 63. In both FIGS. 11A and 11B, the cross-section of the gratings 40e and 40f (disposed on optical core 30) shown in the figures illustrates the same undulating pattern of the inorganic layer 60 and adhesive layer 50.

As discussed elsewhere herein, the ridges and grooves (or first and second concavities) of the multilayer gratings discussed herein may have any appropriate shape. The embodiments of FIGS. 10A, 10B, 11A, and 11B are examples only and not intended to be limiting in any way.

Finally, FIG. 12 is an illustrative example of possible methods for measuring dimensions on an undulating layer of a multilayer grating according to the present description. For example, one method of measuring the thickness of the undulating inorganic layer is to take multiple measurements of the distance between the first major surface and the second major surface of the inorganic layer 60, such as the measurements s1 through s8 shown in FIG. 12. One method of doing this is to randomly select a number of points on the first major surface 61 of inorganic layer 60 and then to draw a straight line to the closest corresponding point on the second major surface 62. Then the spacing average S_{avg} is determined by taking the average of these measurements, and the spacing standard of deviation S_{sd} is determined.

### Example

Substrate with Separation Packet

A substrate with separation packet was made by depositing a separation packet on ST504 PET film according to methods described in co-pending U.S. Patent Application No. 63/265,650 filed on Dec. 17, 2021, Gotrik, et, al.). The acrylate coating acting as the first layer of the separation packet on SiAlOₓ for release was made on a roll-to-roll vacuum coater similar to the coater described in U.S. Patent Application No. 2010/0316852 (Condo, et al.) with the addition of a second evaporator and curing system located between the plasma pretreatment station and the first sputtering system, and using evaporators as described in U.S. Pat. No. 8,658,248 (Anderson et al.).

This coater was outfitted with a substrate in the form of an indefinite length roll of 0.05 mm thick, 9 inch (22.86 cm) wide ST504. The substrate was prepared for coating by subjecting it to a nitrogen plasma treatment to improve the adhesion of the planarizing acrylate layer to the PET. The film was treated with a nitrogen plasma operating at 50 W using a titanium cathode, using a web speed of 8.0 meters/min and maintaining the backside of the film in contact with a coating drum chilled to 0° C.

On this prepared ST504 PET substrate, a planarizing acrylate layer of SR833 was formed. The acrylate layer was applied by ultrasonic atomization and flash evaporation to make a coating width of 9 inches (22.68 cm). The flow rate of this mixture into the atomizer was 0.67 ml/min to achieve a 375 nm layer, the gas flow rate was 60 standard cubic centimeters per minute (SCCM), and the evaporator temperature was 260° C. Once condensed onto the PET substrate, this monomeric coating was cured immediately with an electron beam curing gun operating at 7.0 kV and 4.0 mA.

The release layer of SiAlOₓ was deposited in-line with the previous acrylate coating step. This silicon aluminum oxide layer was laid down using an alternating current (AC) reactive sputter deposition process employing a 40 kHz AC power supply from a SiAl target. The voltage for the cathode during sputtering was controlled by a feed-back control loop that monitored the voltage and controlled the oxygen flow such that the voltage would remain constant. The system was operated at 16 kW of power to deposit an 11 nm thick layer of silicon aluminum oxide onto the planarizing organic acrylate layer.

The transferrable acrylate layer (separation packet) of SR833 was deposited in-line with the previous SiAlOₓ deposition. The acrylate layer was applied by ultrasonic atomization and flash evaporation to make a coating width of 9 inches (22.68 cm). The flow rate of this mixture into the atomizer was 0.67 ml/min to achieve a 375 nm layer, the gas flow rate was 60 standard cubic centimeters per minute (SCCM), and the evaporator temperature was 260° C. Once condensed onto the SiAlOₓ layer, this monomeric coating was cured immediately with an electron beam curing gun operating at 7.0 kV and 4.0 mA.

### Nanostructure Tooling Film

A nanostructure tooling film was prepared by die coating a photocurable acrylate resin mixture (prepared by combining and mixing PHOTOMER 6210, SR238, SR351 and TPO in weight ratios of 60/20/20/0.5) onto ST505 film. The coated film was pressed against a nanostructured nickel surface attached to a steel roller controlled at 60° C., using a rubber covered roller at a speed of 15.2 meters/min. The nanostructured nickel surface consisted of subwavelength gratings arranged as a 2D exit pupil expander pattern. The pattern has three grating regions that function as the input coupler, exit-pupil expander, and output coupler when attached to an appropriate substrate.

The coating thickness of the acrylate resin mixture on the film was sufficient to fully wet the nickel surface and form a rolling bead of resin as the coated film was pressed against the nanostructured nickel surface. The film was exposed to radiation from two Fusion UV lamp systems (obtained under the trade designation “F600” from Fusion UV Systems, Gaithersburg, MD) fitted with D bulbs both operated at 142 W/cm while in contact with the nanostructured nickel surface. After peeling the film from the nanostructured nickel surface, the nanostructured side of the film was exposed again to radiation from a single Fusion UV lamp system.

A silicon containing release film layer assembled according to methods described in U.S. Pat. No. 6,696,157 (David et al.) and U.S. Pat. No. 8,664,323 (Iyer et al.) and U.S. Patent Application Publication No. 2013/0229378 (Iyer et al.) was applied to the nanostructure tooling film in a parallel plate capacitively coupled plasma reactor. The chamber has a central cylindrical powered electrode with a surface area of 1.7 m² (18.3 ft²).

The nanostructured tooling film was placed on the powered electrode, and the reactor chamber was pumped down to a base pressure of less than 1.3 Pa (2 mTorr). O₂ gas was flowed into the chamber at a rate of 1000 SCCM. Treatment was carried out using a plasma enhanced CVD method by coupling radiofrequency (RF) power into the reactor at a frequency of 13.56 MHz and an applied power of 2000 Watts. Treatment time was controlled by moving the nanostructure tooling film through the reaction zone at rate of 9.1 meter/min (30 ft/min) resulting in an approximate exposure time of 10 seconds. After completing the deposition, RF power was turned off and gasses were evacuated from the reactor.

After the first treatment, a second plasma treatment was carried out in the same reactor without returning the chamber to atmospheric pressure. HMDSO gas is flowed into the chamber at approximately 1750 SCCM to achieve a pressure of 9 mTorr. 13.56 MHz RF power was subsequently coupled into the reactor with an applied power of 1000 W. The film was then carried through the reaction zone at a rate of 9.1 meter/min (30 ft/min) resulting in an approximate exposure time of 10 seconds. At the end of this treatment time, the RF power and the gas supply were stopped, the chamber was returned to atmospheric pressure, and the release-treated nanostructure tooling film was removed from the chamber.

### Template Substrate

The substrate with separation packet was corona treated at an energy density of 1,000 J/cm\hat{ }2. An acrylate solution was prepared by adding 74 wt % PHOTOMER 6210 with 25 wt % SR238 and 0.014% TPO to create Acrylate Resin A. Acrylate Resin A was diluted to make a solution of 10 wt % Acrylate Resin A, 54 wt % PGME, and 36% MEK. The diluted solution was slot-die coated onto the corona treated substrate with separation packet at a rate of 3 meters/minute. The solution was coated 10.16 cm wide and pumped with a syringe pump (Harvard Apparatus, Holliston, Massachusetts) at a rate of 3 SCCM.

The film was then dried at ambient conditions for 3 minutes before entering a nip. At the nip, the coated substrate with separation packet was laminated to the release treated nanostructure tooling film made in the previous step.

The nip consisted of a 90-durometer rubber roll and a steel roll set at 54° C. The nip was engaged by two Bimba air cylinders (Bimba, University Park, IL) pressurized to 0.55 MPa.

The coated acrylate solution was cured using a Fusion D bulb (Fusion UV Systems, Gaithersburg, MD) and the cured acrylate mixture was separated from the release treated template film leaving behind the cured acrylate coating with a replica of the subwavelength gratings on the substrate with separation packet. Web tensions were set to be approximately 0.0057 N/m.

### Transfer Film

An exemplary transfer film was prepared using a sputtering coater to deposit the high index (n˜2.4) TiOₓ layer onto the template substrate described above. Three TiOₓ targets powered at 3 kW were used to deposit 15 nm of TiOₓ at 0.9 m/min sequentially in four passes using a DC reactive process with an argon/oxygen gas mixture (˜2% O₂) to result in a nominally 60 nm thick layer of TiOₓ (after deposition, x is approximately equal to 2). The transferrable acrylate film with the TiOₓ coating had a thickness of nominally 350-550 nm.

A single pattern was cut from the roll of transfer film. A thin layer of FG1901 was applied over the TiOₓ surface by spin-coating at 200 rpm for 5 seconds followed by 4000 rpm for 30 seconds at 0.48% solids dilution in Cyclohexane/Toluene (9.05%: 90.95% by weight) to result in a ˜45 nm thick layer.

### Waveguide

The above adhesive-coated TiOₓ/gratings were laminated onto a High Index Glass Wafer by placing the paired substrates in a 120 mm CNI nanoimprint tool (NIL Technologies ApS, Lyngby, Denmark) at a temperature of 140 C and pressure of 6 bars for 5 minutes. Once the laminated pair had cooled to room temperature, the template substrate was pulled away from the surface of the glass wafer, initiating a crack at the separation interface between the carrier substrate and the transfer acrylate. This resulted in the transfer acrylate and TiOₓ/grating being left behind on the glass wafer.

The remaining acrylate template was removed from the TiOₓ grating by O₂ plasma etching using a 40 kHz YES G-1000 plasma system (Yield Engineering Systems, Fremont, CA) for 140 minutes at 500 W and 230 millitorr of oxygen pressure, on a grounded electrode.

The completed waveguide was illuminated with a projector (Venus III 40D, Coretronic Corporation, Hsinchu, Taiwan) directed onto the input coupler grating and an image was observed at the output coupler, confirming that it functioned as an image preserving waveguide.

### Materials

| Designation | Description | Source |
|---|---|---|
| PHOTOMER 6210 | Urethane acrylate oligomer available under the | IGM Resins, |
| | trade designation PHOTOMER 6210 | Charlotte, NC, |
| | | United States |
| SR238 | 1,6-hexanediol diacrylate available under the | Sartomer Americas, |
| | designation SR238 | Exton, PA, United |
| | | States |
| SR351 | Trimethylolpropane triacrylate available under | Sartomer Americas, |
| | the designation SR351 | Exton, PA, United |
| | | States |
| SR833 | tricyclodecane dimethanol diacrylate | Sartomer Americas, |
| | | Exton, PA, United |
| | | States |
| HMDSO | Hexamethyldisiloxane | Gelest Inc., |
| | | Morrisville, PA, |
| | | United States |
| TiOₓ | Titanium oxide (sputtering target) | Protech Materials, |
| | | Hayward, CA, |
| | | United States |
| SiAl | Si(90%)/Al(10%) rotary sputtering target | Soleras Advanced |
| | | Coatings US, |
| | | Biddeford, ME, |
| | | United States |
| MEK | Methyl ethyl ketone | Brenntag Great |
| | | Lakes, Wauwatosa, |
| | | WI, United States |
| Cyclohexane | Cyclohexane, ACS reagent grade (>99%) | Sigma-Aldrich |
| | | Corporation, St. |
| | | Louis, MO, United |
| | | States |
| PGME | Propylene Glycol Methyl Ether | Brenntag Great |
| | | Lakes, Wauwatosa, |
| | | WI, United States |
| Toluene | Toluene | Sigma-Aldrich |
| | | Corporation, St. |
| | | Louis, MO, United |
| | | States |
| TPO | Diphenyl(2,4,6-trimethylbenzoyl)phosphine | BASF, Florham |
| | oxide available under the trade designation | Park, NJ, United |
| | IRGACURE TPO | States |
| O₂ | Oxygen (UHP compressed gas) | Oxygen Service |
| | | Company, St. Paul, |
| | | MN, United States |
| N₂ | Nitrogen (UHP compressed gas) | Oxygen Service |
| | | Company, St. Paul, |
| | | MN, United States |
| Ar | Argon (UHP compressed gas) | Oxygen Service |
| | | Company, St. Paul, |
| | | MN, United States |
| CO₂ | Carbon Dioxide (UHP compressed gas) | Oxygen Service |
| | | Company, St. Paul, |
| | | MN, United States |
| FG1901 | A high molecular weight maleated styrene- | Kraton Polymers |
| | butadiene-styrene available under the trade | LLC, Houston, TX, |
| | designation KRATON FG1901 G | United States |
| ST504 | Polyester film available under the trade | Du Pont Teijin |
| | designation MELINEX ST504 | Films, Chester, VA, |
| | | United States |
| ST505 | Polyester film available under the trade | Du Pont Teijin |
| | designation MELINEX ST505 | Films, Chester, VA, |
| | | United States |
| High Index Glass | 1 mm thick by 100 mm diameter glass wafers | Hoya, Tokyo, Japan |
| Wafer | sold under the designation TAFD55-W | |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description. “substantially equal” will mean about equal where about is as described above. If the use of “substantially parallel” is not otherwise clear to one of ordinary skill in the art in the context in which it is used and described in the present description. “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. An optical waveguide comprising:
an optical core configured to propagate an image light therealong; and
first and second multilayer gratings disposed on the optical core, the first multilayer grating configured to receive an image light from an image projector and inject at least a portion of the received image light into the optical core, the injected image light propagating along the optical core primarily by total internal reflection, the second multilayer grating configured to receive at least a portion of the injected image light and extract at least a portion of the received injected image light from the optical core for viewing by a viewer, each of the first and second multilayer gratings comprising:
an inorganic undulating layer comprising opposing outermost undulating major surfaces nestingly aligned with each other to have a wave-like shape along a width direction of the inorganic undulating layer and forming a plurality of substantially parallel ridges and grooves, the ridges and the grooves extending along an orthogonal length direction of the inorganic undulating layer; and
a planarizing adhesive layer disposed between the inorganic undulating layer and the optical core and substantially planarizing one of the undulating major surfaces of the inorganic undulating layer and bonding the inorganic undulating layer to the optical core.

2. The optical waveguide of claim 1, wherein the first and second multilayer gratings have different width directions.

3. The optical waveguide of claim 1, wherein an undulation amplitude of at least one of the first and second multilayer gratings varies along the width direction thereof.

4. The optical waveguide of claim 1, wherein the planarizing adhesive layer defines a minimum distance dₘᵢₙ between the inorganic undulating layer and the optical core, and wherein dₘᵢₙ>5 nm.

5. The optical waveguide of claim 1, wherein for at least one of the first and second multilayer gratings, a minimum separation between the optical core and the grooves of the multilayer gratings changes along the width of the multilayer grating.

6. The optical waveguide of claim 1, wherein for at least one of the first and second multilayer gratings, in a planar cross-section of the multilayer grating that is orthogonal to the length direction of the multilayer gratings, and for two different locations on the multilayer grating L1 and L2, each location comprising one ridge and one directly adjacent groove, where the area between the optical core and the ridge at L1 is Aᵣ₁, the area between the optical core and the groove at L1 is A_{g1}, the area between the optical core and the ridge at L2 is Aᵣ₂, and the area between the optical core and the groove at L2 is A_{g2}, Aᵣ₁+A_{g1} is within 30% of Aᵣ₂+A_{g2}.

7. The optical waveguide of claim 1, wherein for at least one of the first and second multilayer gratings, the multilayer grating further comprises a planarizing cover layer conformally covering the inorganic undulating layer opposite the planarizing adhesive layer and substantially planarizing the inorganic undulating layer.

8. The optical waveguide of claim 1, wherein the first and second multilayer gratings are disposed on opposite major sides of the optical core.

9. The optical waveguide of claim 1 further comprising a connecting adhesive portion disposed between, and continuously and seamlessly connecting, the planarizing adhesive layers of the first and second multilayer gratings.

10. The optical waveguide of claim 1 further comprising a connecting substantially non-undulating inorganic layer disposed between, and continuously and seamlessly connecting, the inorganic undulating layers of the first and second multilayer gratings.

11. The optical waveguide of claim 1, wherein each of the first and second multilayer gratings further comprises a planarizing cover layer conformally covering the inorganic undulating layer opposite the planarizing adhesive layer and substantially planarizing the inorganic undulating layer, and wherein the optical waveguide further comprises a substantially planar connecting cover layer disposed between, and continuously and seamlessly connecting, the planarizing cover layers of the first and second multilayer gratings.

12. The optical waveguide of claim 11, wherein for at least one visible wavelength in a visible wavelength range extending from about 420 nm to about 680 nm, an index of refraction of the planarizing cover layer is less than index of refraction of the inorganic undulating layer by at least 0.5.

13. The optical waveguide of claim 1, wherein the inorganic undulating layer comprises one or more of titanium dioxide (TiO₂), zirconium oxide (ZrOₓ), titanium oxide (TiOₓ), SiO₂, Al₂O₃, CeO₂, ZnO, Nb₂O₅, Ta₂O₅, HfO₂, SiAlOₓN_{y}, Si₃N₄, Nb-doped TiO₂, and ZrO₂.

14. An optical system comprising the optical waveguide of claim 1 and the image projector configured to emit the image light, the first multilayer grating configured to receive the emitted image light and inject at least a portion of the received image light into the optical core.

15. The optical waveguide of claim 1, wherein for at least one visible wavelength in a visible wavelength range extending from about 420 nm to about 680 nm, the planarizing adhesive layer has an index of refraction of between about 1.35 to about 2.5.

16. The optical waveguide of claim 1, wherein for at least one visible wavelength in a visible wavelength range extending from about 420 nm to about 680 nm, the planarizing adhesive layer has an index of refraction of about 1.5.

17. The optical waveguide of claim 1, wherein a minimum spacing between the optical core and the plurality of substantially parallel ridges and grooves is greater than about 5 nm.

18. The optical waveguide of claim 1, wherein as average spacing between the grooves and the optical core is less than about 500 nm.

19. An optical waveguide comprising:
an optical core configured to propagate an image light therealong; and
a continuous seamless multilayer disposed on a major side of the optical core and comprising:
a continuous seamless inorganic layer undulated in a plurality of discrete spaced apart regions of the inorganic layer to form a plurality of spaced apart undulated inorganic layer portions of an otherwise non-undulated inorganic layer, each of the undulated inorganic layer portions comprising opposing outermost undulating major surfaces nestingly aligned with each other and forming a plurality of substantially parallel ridges and grooves of the undulated inorganic layer portion extending along a length-direction of the undulated inorganic layer portion and arranged along an orthogonal width-direction of the undulated inorganic layer portion; and
a continuous seamless adhesive layer disposed between the inorganic layer and the optical core and substantially conforming to the ridges and grooves of each of the undulated inorganic layer portion and bonding the inorganic layer to the optical core, wherein:
a first of the undulated inorganic layer portions is configured to receive an image light from an image projector and inject at least a portion of the received image light into the optical core, the injected image light propagating along the optical core primarily by total internal reflection;
a second of the undulated inorganic layer portions is configured to receive at least a portion of the injected image light along a first direction and redirect the injected image light as a redirected image light propagating along a different second direction along the optical core primarily by total internal reflection; and
a third of the undulated inorganic layer portions is configured to receive at least a portion of the redirected image light and extract at least a portion of the received redirected image light from the optical core for viewing by a viewer.

20. A method of making an optical waveguide comprising:
providing a temporary carrier comprising a major structured surface comprising, in a plurality of discrete spaces apart regions, a plurality of alternating first ridges and first grooves;
conformally disposing an inorganic layer on the major structured surface of the temporary carrier so that both a first major surface thereof facing the temporary carrier and a second major surface thereof facing away from the carrier substantially conform to the major structured top surface of the temporary carrier to form a continuous seamless inorganic layer having a plurality of undulated inorganic layer portions in an otherwise non-undulated inorganic layer, such that in each of the undulated inorganic layer portions, the first and second major surfaces of the layer portion define a spacing average S_{avg} and a spacing standard of deviation S_{sd} therebetween, S_{sd}/S_{avg} less than about 0.5;
substantially conformally coating the second major surface of the inorganic with an adhesive layer and substantially planarizing the inorganic layer to form a structured adhesive layer having a major structured top surface facing and substantially conforming to the second major surface of the inorganic layer and an opposing substantially planar major surface;
adhering the substantially planar major surface of the structured adhesive layer to a major surface of an optical core configured to propagate an image light therealong primarily by total internal reflection; and
removing the temporary carrier from the first major surface of the inorganic layer.
